(19) United States
(12) Patent Application Publication
(10) Pub. No.: US 2002/0162589 A1
(43) Pub. Date: Nov. 7, 2002

(54) Fluid control device with reduced sound generation

(76) Inventors: Frederick A. Lorch, Ashland, MA (US); Gordon Sharp, Newton, MA (US); Jerome Schaufeld, Framingham, MA (US); Richard Clayton, Newton, MA (US)

Correspondence Address: Patent Services Group, Honeywell International Inc., 101 Columbia Road, Morristown, NJ, 07962, US

(21) Appl. No.: 10/060,074

(22) Filed: Jan. 29, 2002

Related U.S. Application Data
(63) Continuation of application No. 08/559,352, filed on Nov. 16, 1995, now abandoned.

(51) Int. Cl. F16K 15/00

(52) U.S. Cl. 137/517

(57) ABSTRACT

A fluid control device with a reduced sound generation. The device is a nozzle-type valve that has a converging portion, a diverging portion and a throat therebetween. A diverging portion acts as a diffuser and may be conical or may have a slight curvature. In each, the diffusion angle is less than 20° so that turbulence of fluid flowing through the valve is minimized and a boundary layer is maintained between the fluid and an inside surface of the fluid control device. A control system that uses such a fluid control device is also disclosed and such device may be used either in a supply conduit or an exhaust conduit.

### BACKGROUND OF THE INVENTION

1. Field of the Invention

This invention relates to a fluid control device with reduced sound generation.

2. Background of the Invention

In forced air heating or air conditioning systems it is often desirable to locally control the flow of air into a particular area such as, for example, the heating zones in a building. The varying demands placed on the air delivery system by the local controls may introduce substantial fluctuations in the air pressure in a supply conduit. If no steps are taken to counteract these fluctuations, each local adjustment may affect the balance of the entire system, causing variations in the supply of the air to at least some of the other areas. U.S. Pat. No. 3,403,852, issued Oct. 1, 1968 to Gorchev describes one attempt to solve the above-noted problem by providing a valve which maintains a constant volume of fluid flow in a conduit within a range of static pressures in the system.

A valve based on the valve disclosed in Gorchev is commercially available from Phoenix Controls and is illustrated in FIG. 1. More particularly, a venturi-type valve 100 has a housing 102 with a reduced diameter throat 104. A cone 106 having a spring package 107 is mounted on a shaft 108 that is positioned in a housing 102 near the throat area 104. Shaft 108 is supported in housing 102 by a pair of brackets 110 and 112. The position of shaft 108 relative to housing 102, and thus of cone 106 in throat 104, is controlled by an actuator 114 through linkages 116 and 118, pivot arm 120 and linkage 122. A potentiometer 124 located at the pivot point of arm 120 provides an output which is indicative of the position of the shaft 108 and thus the cone 106 in the throat 104. As shown in FIG. 1, the valve body has an abrupt diffusing portion.

Control devices, such as the valve described above, that provide a constant volume flow over a range of pressures have provided adequate fluid control in heating and air conditioning systems for many years by several manufacturers. However, one enduring problem with fluid handling valves of this type is the sound that is generated when they are used. Such sound from a fluid control device can travel across long distances through ducts and become very annoying to individuals within the room or area which is being controlled. This unpleasant or unwanted sound is generally characterized as noise. This noise may be even more unpleasant if the control device is located close to the room or space which is occupied. The unwanted sound generated by the air system often can interfere with spoken communication, make it difficult to hear on the phone and make what should be a comfortable space generally unpleasant because of the sound.

Most conventional methods for reducing the sound emitted from the control devices have focused on the interruption of the transmission of the sound. That is, the path between the source of the sound and the receiver has been conditioned to absorb or attenuate the sound. Various sound absorbing materials have been used to line the interior surfaces of the conduit to attenuate the noise. Some materials which have been used include fiberglass, mineral wool insulation and foams, both open and closed cell. The foam material has been used less frequently due to its high material cost. One of the drawbacks of the duct lining is that in order to achieve any meaningful degree of low frequency sound reduction, very long lengths of conduit must be lined. This increases the cost of an air delivery system and sometimes is simply not feasible when the available space for the ducting is limited. Additionally, the duct lining may also deteriorate over time, shed fibers and/or provide a medium for mold and spore growth. Often ventilation design specifications stipulate that duct lining should not be used because of the above-mentioned problems.

Another method for noise reduction is noise cancellation in which the frequency spectrum and the amplitude of the sound is measured and analyzed. A source of sound is then introduced that is 180 degrees out of phase from the noise and thus eliminates the noise. These systems are very expensive and require great precision to operate properly. If any component of the system is slightly miscalibrated then the desired noise attenuation will not occur.

There are other means to reduce the sound generated by an air control system. For example, when designing the air system various operating parameters may be adjusted to provide a quieter system. Typically, the sound created by an air control device tends to increase as the velocity of air through the device increases; additionally, the sound tends to increase as the pressure drop across the device increases. Given these operational guidelines, quieter air control systems have been designed with reduced operational parameters so that the maximum velocity through a given control device is on the order of 1000 feet per minute (FPM) rather than the 2000 to 2500 FPM as with conventional systems. Additionally, the maximum pressure drop across the control device has been reduced to less than 0.75 inches w.c. rather than the conventional 1.50-2.00 inch w.c. While the noise associated with a system having these parameters is reduced, this necessarily results in larger duct sizes, additional control devices, greater balancing requirements and higher initial costs. The growth in duct size and quantity of control devices also increases the amount of building space required for the air control system, correspondingly reducing the space available for the occupant.

Accordingly, the prior art lacks a fluid control device which itself has been adapted to reduce the sound generated.

### SUMMARY OF THE INVENTION

The present invention is a fluid control device that includes a converging portion, a diverging portion and a throat between the converging and diverging portions. The diverging portion is provided with a predetermined diffusion angle and length that is sufficient to reduce the sound generated by the flow of a fluid through the valve. Preferably, various aspects of the valve includes a diffusion angle less than or equal to 20°. Additionally, the diffusing section may be conical and may extend between the throat and the nominal diameter of the valve body. Additionally, the transition between the converging portion and the diverging portion may be smooth and continuous. Further, another aspect of the invention includes a continuous transition between the diverging portion and the nominal diameter.

Another embodiment of the invention provides a valve for controlling the flow of fluid in a conduit. The valve includes a valve body that defines a passage for allowing fluid to flow from an upstream position to a downstream position. The valve body has a converging portion, a diverging portion and a throat between the converging and diverging portions. The diverging portion is provided with a predetermined diffusion angle and a length that is sufficient to reduce the sound generated by fluid flow through the valve. Preferably, the valve according to this embodiment of the invention provides a fluid flow control mechanism mounted to the valve body that operates to control the volume of the fluid flowing throughout the valve. The mechanism includes a flow control member disposed within the valve body at a position upstream of the throat, the flow control member has an outer periphery that forms a flow orifice within the passage. A shaft is provided onto which the flow control member is mounted, the shaft is axially movable by the control mechanism. A spring may be mounted on the shaft to bias the fluid control member toward a predetermined position. The spring allows for the fluid control member to move axially with respect to the shaft in response to fluid flow variations such that a constant volume of fluid may pass through the passageway of the body.

In another embodiment of the invention, a control system is provided that ventilates a space which reduces noise generation. The control system includes an exhaust conduit that is adapted to remove air from the ventilating space. An exhaust blower is fluidly connected to the conduit and draws air through the conduit. A flow control valve is disposed in the conduit for controlling the flow of fluid in the conduit. The flow control valve has a nozzle including a converging portion and a diverging portion and a throat therebetween wherein the diverging portion includes a conical configuration that has a diffusion angle of less than about 20° and extends a sufficient length to reduce the generation of noise as fluid flows through the valve. In another aspect of this embodiment the control system may include a supply conduit for supplying the ventilating space with air. A valve may be disposed within the supply conduit for controlling the flow of fluid through the supply conduit, the supply control valve having a nozzle with a converging and a diverging portion and a throat therebetween. The diverging portion of the supply control valve has a diffusion angle of less than about 20° and extends a sufficient length to reduce the sound generated by the flow of fluid through the valve.

Accordingly, it is an object of the present invention to provide a quieter ventilation system for use in a building by reducing the amount of noise produced by the air control devices.

It is a further object of the invention to reduce the amount of sound produced at the supply side of the ventilation system by providing an air control device which is modified to produce less sound.

Another object of the invention is to reduce the amount of sound produced at the exhaust side of a ventilation system by providing an air control device which is modified to produce less sound.

### BRIEF DESCRIPTION OF THE DRAWINGS

The foregoing and other objects of the invention will be appreciated more fully from the detailed description with the following drawings, in which:

FIG. 1 is a partial cutaway view of a conventional fluid control valve;

FIG. 2 is an axial cross-sectional view of an illustrative embodiment of the fluid control device of the present invention;

FIGS. 3A and 3B are perspective views of a valve body of various embodiments of the present invention at a 7° diffusion angle and a 12° diffusion angle;

FIG. 4A illustrates an axial cross sectional view of another embodiment of the invention and shows a curved diffuser;

FIG. 4B illustrates an axial cross sectional view of valve body with a discontinuity in the diffusing portion;

FIG. 5 illustrates a laboratory ventilation system into which the invention may be incorporated; and

FIGS. 6 and 7 are graphs showing a comparison between the noise generated by a standard valve and the valve with a diffuser according to the present invention.

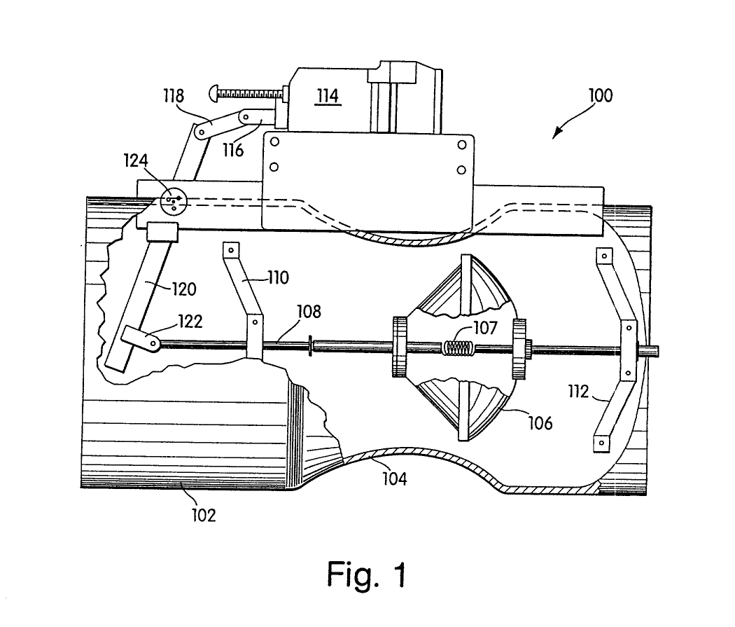

### DETAILED DESCRIPTION OF THE INVENTION

Excessive noise generated by air control systems has long been an annoyance to people who occupy a room in a building with such a system. Previous attempts to solve the problem have focussed on interrupting the sound transmission and the reduction of sound generated by modifying the operational parameters of a control valve. Each of these past attempts has met with varying success. Various tests performed on the valves in an air control system identified that one source of the sound is the turbulence in the valve body as the air expanded in the diverging portion of the nozzle. Testing indicated that the noise was created by eddies and backflow which occur in the abrupt diverging portion of the valve bodies of the prior art. When the swirls and eddies are large, a low frequency noise was created which is difficult to absorb or reduce once it is created. The present invention, solves the problem by modifying the value to provide a diffusing portion with a sufficient angle and length to reduce the noise generated by the valve. The diffusion portion of the present invention minimizes the eddies and backflow in the diverging portion and thus reduces the sound generated by the flow of air through the valve.

Without wishing to be tied to any particular fluid dynamics theory, it is generally thought that the turbulence and eddies at the diverging portion of the nozzle are created because an abrupt increasing diameter of the nozzle of the prior art causes a separation of the fluid flow from the interior wall of the valve body. This separation causes a swirl or a backflow of fluid which interrupts the smooth flowing of fluid through the nozzle and generates a low frequency sound. In the present invention, the smooth defusing contour of the diverging portion allows the fluid to expand back to the nominal dimension of the conduit. Thus the outwardly tapered diameter allows the fluid to flow more smoothly out of the valve and reduces the generation of sound, particularly in the low frequency range; that is, sound at 500 Hz or less.

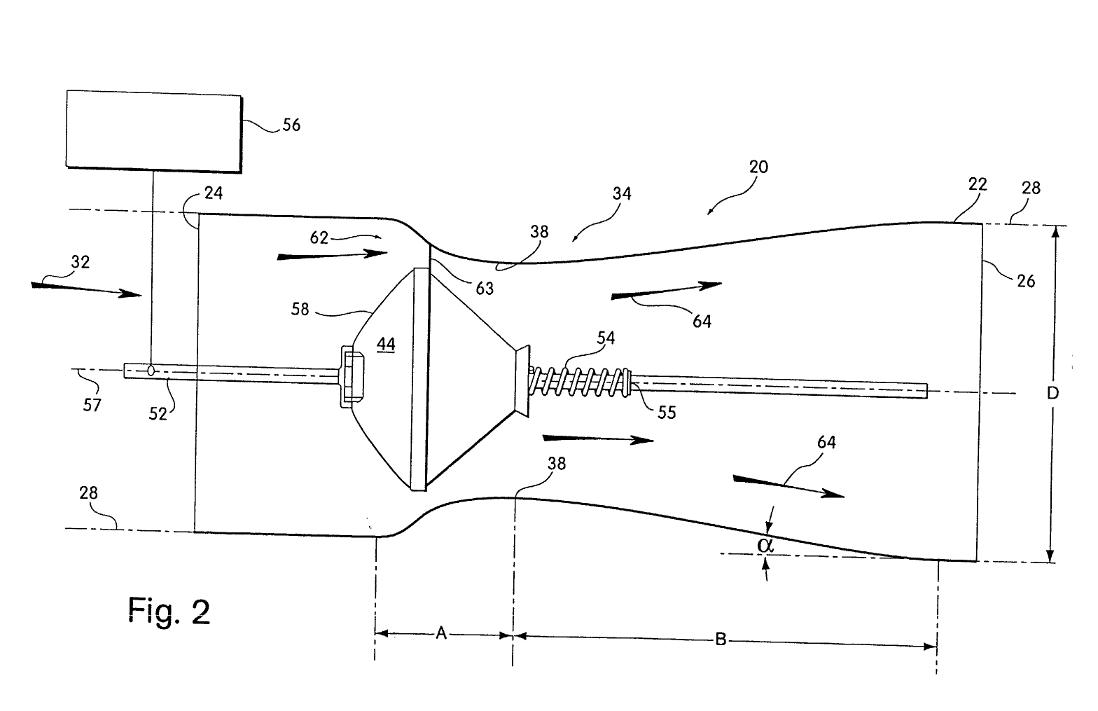

A fluid control device 20 with reduced sound generation in accordance with the present invention is illustrated in FIG. 2 and includes a body 22 having an inlet 24 and an outlet 26 and a conduit 28 through which a fluid may flow such as a supply or exhaust duct in a building ventilation system. The valve regulates the flow of fluid through the conduit in the direction indicated by arrow 32. The tubular member 22 has a varied cross-section along its axial length that forms a nozzle 34 that has a converging portion A and a diverging portion B. A throat 38, provided between the converging portion and the diverging portion, defines he narrowest portion of the body. The valve may also include a cone 44 that is centrally disposed and mounted for axial movement within the valve body at a location upstream of the throat 38, providing a constant volume of air flowing through the valve when the static pressure of the fluid in the valve varies.

Again with reference to FIG. 2, the diverging portion may be adapted to be used with a venturi-type valve that is designed to provide flow control. As will be apparent to those skilled in the art, with a length and diffusing angle to reduce sound generating any orifice valve may be modified to include a diverging portion. More particularly, in the embodiment of FIG. 2, constant volume control may be provided by the axial movement of the cone 44. The cone is mounted on an assembly that includes a shaft 52, a spring 54 and an actuator 56 that moves the shaft in an axial direction as represented by arrow 57. The cone 44 is mounted on the shaft 52 and has a smoothly increasing contour 58 along its upstream side. The largest diameter of the cone is positioned proximate to the converging portion B of the nozzle to create an annular orifice 63. The cone 44 moves axially on the shaft to increase or decrease the orifice area as indicated by arrow 62. The spring 54 biases the cone in an axial position against a spring stop 55 such that when fluid flows through the valve, a pressure force across the valve moves the cone back and forth to maintain a constant volume flow through the valve. Thus, when the pressure drop across the valve increases, the cone is pushed further toward the throat of the valve to reduce the area of the orifice and thus maintain a constant volume of fluid flowing though the valve. Similarly, when the pressure drop decreases the cone moves away from the throat and the orifice opens to maintain a constant volume of fluid flow. The shaft is axially movable by the actuator 56 so that the flow volume may be adjusted. Typically, operating requirements of the air control system may make changing the volume flow desirable. For example, in a laboratory air control system, discussed in detail below, raising a fume hood sash will typically require a shaft adjustment so that more air will flow through the valve to provide a constant face velocity across the sash opening.

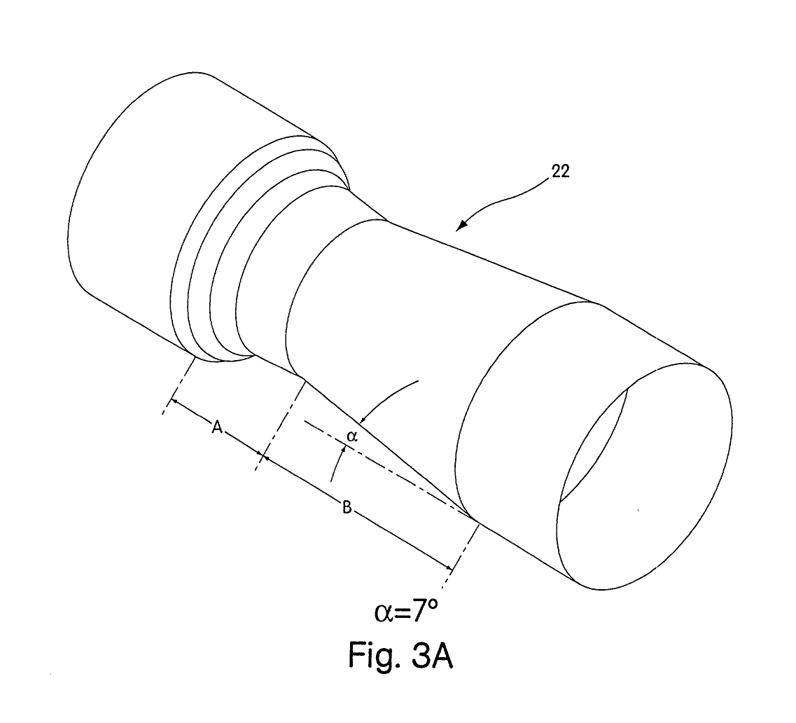

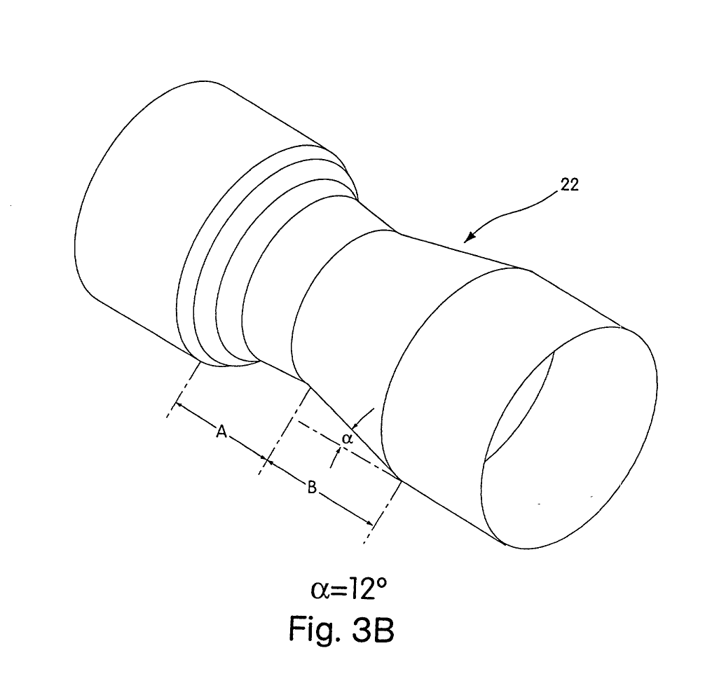

With reference to FIGS. 2, 3A, and 3B, the diverging portion B of the valve body preferably has an outwardly tapered diffuser configuration. In the embodiment illustrated, a conical diffuser begins at the throat 38 and extends until the diameter of the surface extends to the nominal diameter D of the valve housing. Although a cone or frusto-conical configuration is illustrated, other shapes would also be suitable such as a square, a rectangle or an oval, as would be apparent to those skilled in the art.

An angle α is defined by the surface of the cone and a line parallel to the longitudinal axis of the valve body. It has been surprisingly found that the angle α may be selected to reduce the creation of eddies along the diverging portion of the valve which are believed to generate the noise in the valve. The flow of fluid is indicated by arrows 64. The angle α may be any angle less than about 20 degrees, for larger angles the noise reducing effect is decreased as eddies and swirls increase in the fluid stream. Testing has indicated that the preferred angle α is between 5 and 12°. Below 5° it appears that the same beneficial quieting effect occurs, however, the length of the diffuser necessary to expand to the nominal diameter of the valve body may be excessive and may unreasonably increase the cost of the valve body. Additionally, there appears to be some pressure loss which occurs along the diffuser if the angle is less than 5°. Because of the pressure loss and the longer length which is attendant with the smaller angle, preferably, the angle is not less than 5°. The preferred angle α for noise reduction is about 7°. At this angle, the noise generated by the valve is reduced an acceptable amount and the head loss and the length are within acceptable parameters. Depending on a particular application, the diffuser angle may vary about the longitudinal axis and/or axially.

As suggested by a comparison between FIGS. 3A and 3B, the diffuser with an angle α of 12° is substantially reduced in axial length than a diffuser where α equals 7°. Because overall length of a valve may be a consideration when determining the characteristics of the diffuser, the preferred angle α for any particular conical diffuser according to the present invention may be based on both the axial length requirements of the valve body and the diffusing effects of the valve. Of course, other considerations such as head loss, etc. should be evaluated to determine a preferred diffusion angle.

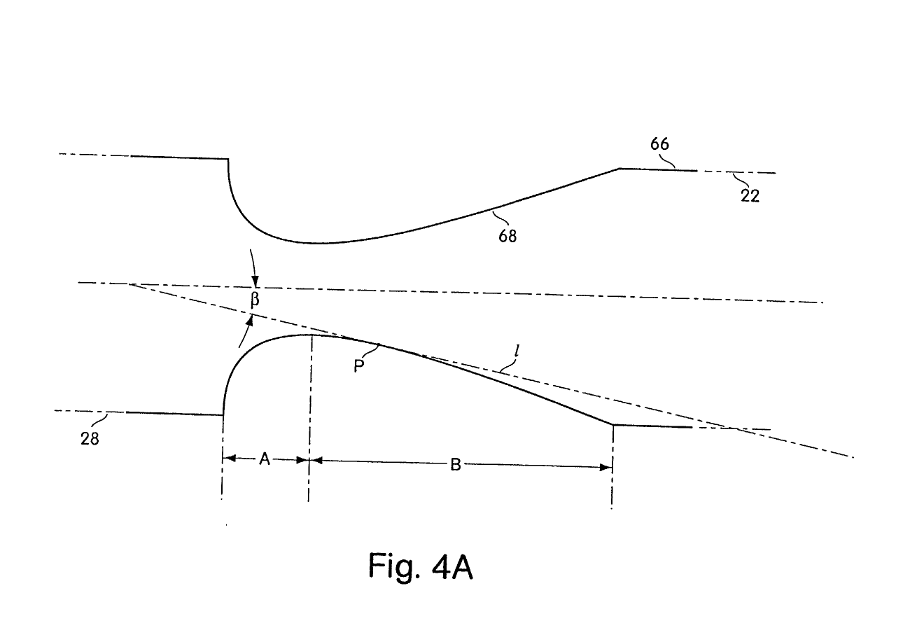

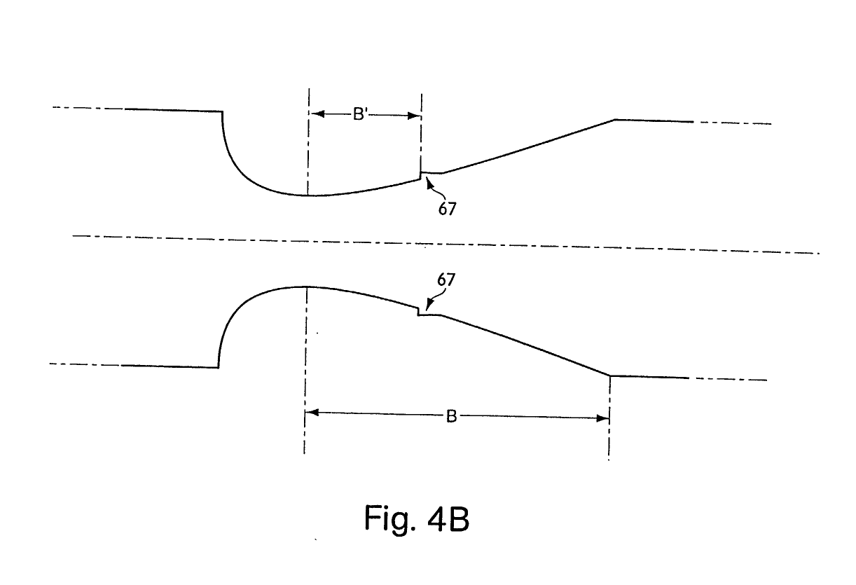

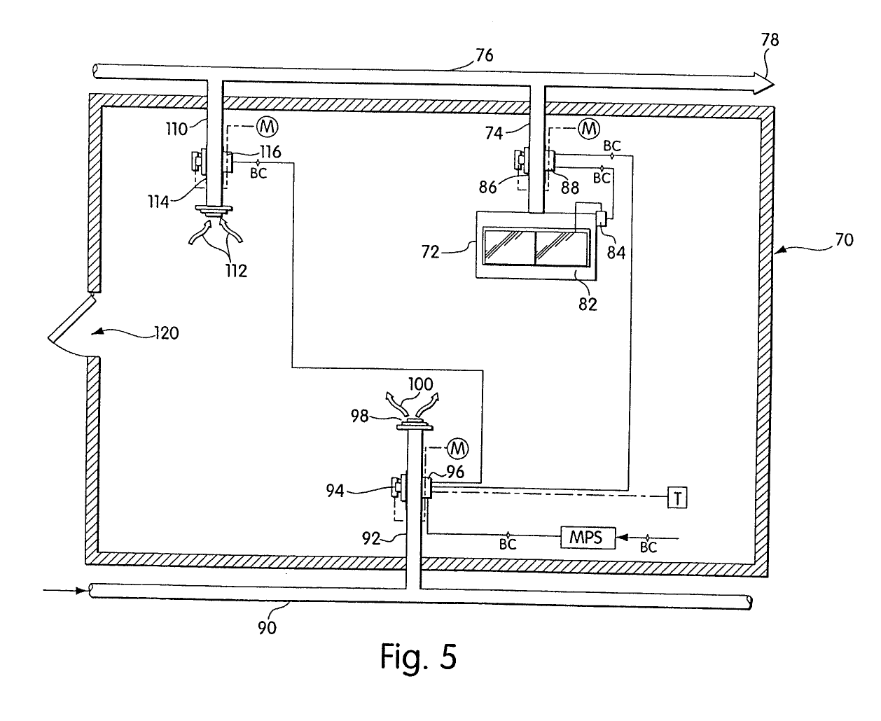

FIG. 4A illustrates another preferred embodiment of the invention. In this embodiment, a valve body 66 includes a slight curving, tapering diffuser portion 68. The slight curvature is selected so that the boundary layer flow is maintained throughout the diffusing portion. As indicated above, at diffusion angles greater than 20° the noise reducing effect of the diffuser diminishes. In this embodiment, an angle β is defined by the tangent line l of any point P along the diverging portion B that intersects a central axis 69 of the valve. In the preferred embodiment, the angle β may be as large as about 20° to maintain the noise reduction characteristics of the diverging portion B. Preferably, the angle β is between 7° and 12°. Either of angles α (shown in FIG. 2) and β (shown in FIG. 4A) may be used to describe the diffusion angle of the diverging portion for any orifice valve.

Additionally, it is possible that the diffuser portion may have a discontinuity in the surface. Small discontinuities may cause high frequency noise which may be absorbed down stream by other noise reduction devices. As illustrated in FIG. 4B, the small discontinuity 67 may take the form of a “step” along the diverging portion where there is an abrupt change in a line formed by an axial cross section. This abrupt change may extend the entire circumference of the valve body at the diffusion proportion. Alternatively, the abrupt change may be disposed at various annular locations along a lateral cross section. Additionally, the diverging portion B, which may be defined by the distance from the throat to the nominal diameter along the diverging surface, preferably has a slope between 5 and 20° to minimize turbulence along the diverging portion.

It should also be understood that the diverging portion need not expand to the nominal diameter of the valve in order to achieve the beneficial effects of this invention. The outwardly tapered portion may have a diffusion angle of less than 20° for a length B′, that is sufficient to reduce the noise generated by the valve, particularly in the low frequency range. B′ may be less than the entire axial distance of the diverging portion. It should be recognized that the discontinuities may take the form of a ripple, a series of ripples or steps that extend in the diverging portion. Again, the length of the outwardly tapered section should be selected that is sufficient to reduce the generation of noise by fluid flowing through the valve.

A representative valve body of the present invention useful in the air control system described above may be made from aluminum sheeting which is spun to form the desired shape of the valve body. The aluminum sheeting may be 0.06 inches thick and is formed into a valve body by rolling the sheet into a cylinder and sealing the seam using an acceptable joining technique. A representative cylinder may have a length that is about 2 feet long and may have a diameter between 6 and 16 inches. The cylinder is then placed around a preformed two-piece mandrel (not shown) which is shaped to the desired configuration of the valve body. The mandrel is separable at its narrow mast portion so that it may be removed from the center of the valve body once the valve body is formed. The mandrel and aluminum cylinder are mounted and spun on a lathe and radial pressure is applied so that the cylinder is forced inward toward the axis, conforming to the shape of the mandrel. The valve body is then removed from the lathe, the mandrel is removed from the valve body and the valve body is complete.

FIG. 4A shows a schematic of one representative application for the valve according to the present invention in the air control system for a laboratory generally indicated by 70. Laboratories typically have specialized ventilation requirements which are more complex than many standard air control applications. One reason for the increased complexity is a fume hood 72 which is generally considered necessary for safe laboratory operation. The fume hood must be carefully controlled at all times to maintain a constant average face velocity (the velocity of air as it passes through the sash opening) that compiles with OSHA and other industry standards. The fume hood has an air conduit 74 which leads to an exhaust air conduit 76 that discharges the air from the system as indicated by an arrow 78. A blower (not shown) operates to pull air through the exhaust air conduit. The constant average face velocity desired at fume hood sash 82 is maintained by a sash sensor 84 which monitors the height of the sash opening. When the sash is opened, the larger open area requires a greater volume of air to maintain the acceptable face velocity. Accordingly, a signal is sent to a fume hood exhaust valve 86 which is adjusted by a controller 88 so that a greater volume of air is permitted to flow through the valve, and thus increase the amount of air which is drawn through the sash opening.

With the increased volume of air flowing through the conduit 74, a supply of air must be provided to make up the fluid drawn through the exhaust conduit. A supply conduit 90 provides air to a room supply conduit 92. A blower (not shown) operates to push air through the supply conduit. A flow control valve 94 disposed in the conduit controls the volume of fluid which is permitted to flow into the room. When the sash is raised, the exhaust valve controller 88 sends a signal to controller 96 for the supply flow control valve to “make up” for the air which is exhausted. The supply air enters the room through the grill 98 as indicated by arrows 100. The supply valve may also respond to temperature and humidity requirements, for example, a sensor T may indicate that more conditioned supply air is required. Typically, the number of people, operating equipment and lighting as well as other factors may cause sensor T to indicate more supply air is desired.

A general exhaust duct 10 is provided to remove air, indicated by arrows 112, from the laboratory when required. An exhaust valve 114 is controlled by a controller 116 that responds to a signal sent from the supply controller 96. Typically, each supply and exhaust valve is operated in a dynamic control system so that safe and comfortable conditions are maintained in the room. The laboratory may be maintained at a negative pressure so that the air flow is always into the laboratory even when a door 120 is in an opened position (as shown).

The diffuser of the present invention may be applied to each of the valves 86, 94 and 114 with beneficial results. The use of the valve in other type control systems will be apparent to those skilled in the art.

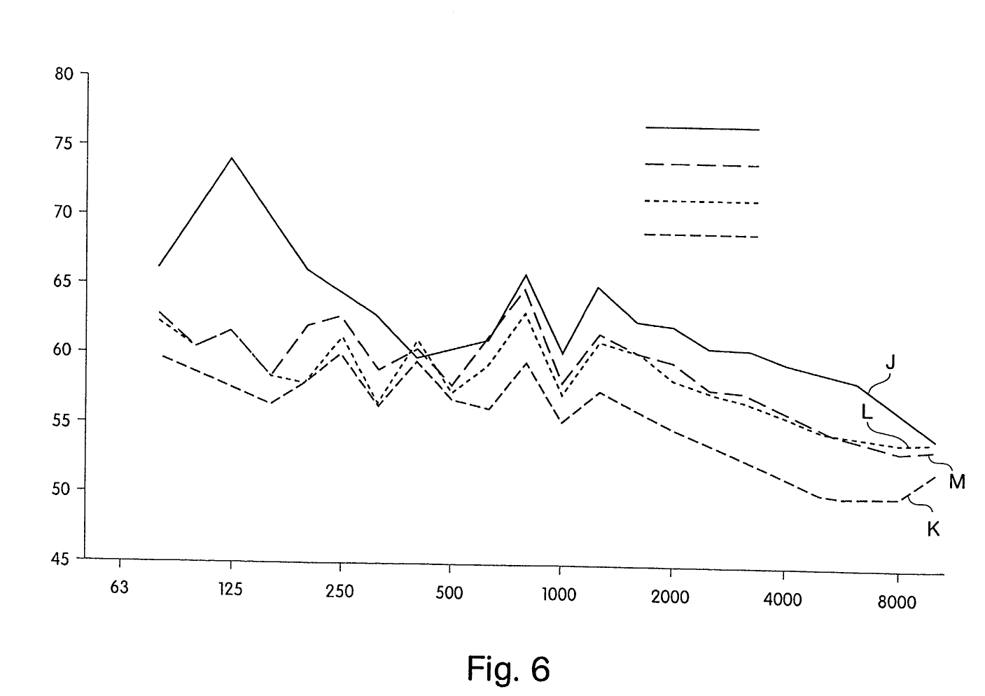

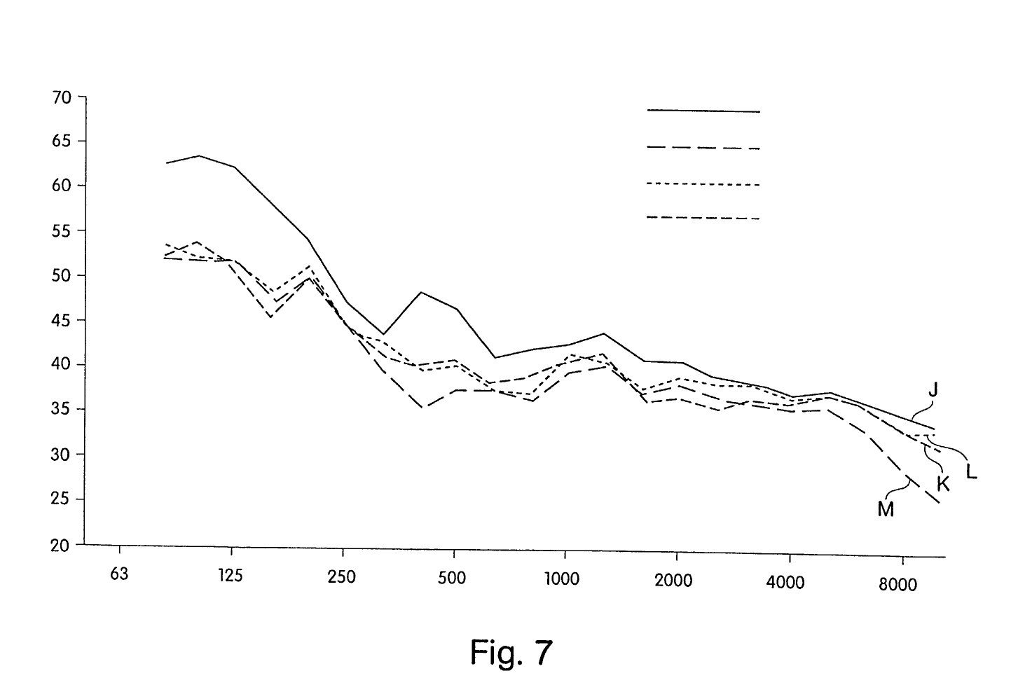

The graphs illustrated in FIGS. 6 and 7 demonstrate that an air valve incorporating the present invention is effective at quieting the sound generated by airflow though the valve. Tests were performed that compared the noise generated along the frequency spectrum by fluid flowing through valves of varying diffusion angles. All testing was conducted according to the Air Conditioning and Refrigeration Instituted Standard 880 (1989). In each of the graphs, the noise produced by the standard venturi type valve of the prior art is represented by a solid line and is designated J. A diffuser with a 7° diffusion angle is represented by the lines of intermediate sized dashes and is designated K. A valve with a 10° diffusion angle is represented by a line of dots and designated L. A valve with a 12° diffuser angle is represented by a line of longer dashes and is designated M. With particular reference to FIG. 6, which shows a graph the Sound Power Level (dB) vs. the frequency (Hz) of the sound for a size 12 make up (supply) valve with 700 Cubic Feet per Minute (CFM) of air traveling therethrough with a 3.0 inch W.C. pressure drop. As clearly shown in the graph, the sound level of the noise was substantially reduced, particularly in the low frequency region. As readily discernible from the graph, at 125 Hz, for example, the standard valve produces a sound of about 74 dB. Each of the diffusers tested were less than 62 dB.

As shown in FIG. 7, a similar reduction of noise was obtained by using the diffuser in a size 10 Exhaust air valve. The valve was tested at 400 CFM at 1.0 inch W.C. Again, the low frequency sound generated by the valves with diffusers is less than the sound produced by the standard valve. The difference between the valves is most marked at the frequencies ranging from approximately 70-500 Hz.

Accordingly, the present invention provides a valve that is adapted to fit within a conduit of a fluid control system and includes a nozzle that converges in the direction of fluid flow along the conduit. A cone is positioned within the conduit such that one end is adjacent the converging portion of the nozzle to create an orifice. The cone is mounted on a shaft that is disposed along the axial line of the conduit and has a spring which allows the cone to move axially so that the size of the orifice may be increased and decreased as the cone moves toward and away from the nozzle. The spring may be adjusted so that a constant volume of air may be passed through the valve at a variety of different pressures. Typically, the shaft itself is adjustable so that the valve itself may be oriented to provide various constant volume flows. The flow control device may be manually controlled. The diverging portion of the nozzle has a diffusion angle of less than 20° so that the sound generated by the valve is reduced.

While there have been shown and described what are considered to be the representative embodiments of the present invention, it will be apparent to those skilled in the art that various changes and modifications may be made therein without departing from the scope of the invention as defined in the appended claims. For example, although cylindrical ducting is disclosed, the invention is contemplated for use with other duct shapes, such as rectangular ducting. The diffuser of the present invention may be used in any orifice type regardless of cross-sectional shape. Similar flow dynamic conditions have been detected in piping systems for liquids and it will be apparent to those skilled in the art that the diffuser valve body of the present invention may be used with liquids as well as gasses.

What is claimed is:

1. A flow control device for reduced sound generation that controls the flow of fluid through a conduit, comprising:
a body having an axis and defining a passage that allows fluid to flow from an upstream position to a downstream position, said valve body having a converging portion, a diverging portion and a throat between said converging and diverging portions, said diverging portion of said passageway having a predetermined diffusion angle and a length that is sufficient to reduce the sound created by the flow of fluids through said fluid control device; and,
a flow regulator supported within said body for controlling the flow of fluid through the conduit.

2. The flow control device of claim 1, wherein said diffusion angle is less than about 12°.

3. The flow control device of claim 1, wherein said diffusion angle is less than about 20°.

5. The flow control device of claim 1, wherein said body has a conical configuration along said diverging portion.

6. The flow control device of claim 1, wherein a transition between said converging portion and said diverging portion is continuous.

7. The flow control device of claim 1, wherein said conduit has a nominal diameter and a transition between said diverging portion and said nominal diameter is continuous.

8. A flow control device having a reduced sound generation that controls flow of fluid through a conduit comprising:
a valve body having an axis and defining a passage that allows fluid to flow from an upstream position to a downstream position, said valve body having a converging portion, a diverging portion and a throat between said converging and diverging portion, said diverging portion having a predetermined diffuser angle for a sufficient length to reduce the sound created by the flow of fluid through said valve, and
a fluid flow control mechanism mounted to said valve body that operates to control said volume of fluid flowing through said valve, said mechanism including;
a flow control member disposed within said valve body at a position upstream of said throat, said flow control member having an outer periphery that forms a flow orifice within said passage,
a shaft onto which said flow control member is mounted, said shaft being axially movable by said control mechanism.

9. The flow control device of claim 8 further comprising a spring mounted on said shaft that biases said fluid control member in a predetermined position, said spring allowing said fluid control member to move axially with respect to said shaft in response to fluid flow variations through said passage such that a constant volume of fluid may pass through said passageway of said valve body.

10. The flow control device of claim 8, wherein said diffusion angle is less than about 12°.

11. The flow control device of claim 8, wherein said diffusion angle is less than about 20°.

12. The flow control device of claim 11, wherein said diffusion angle is between 7° and 12°.

13. The flow control device of claim 8, wherein said diverging portion has a conical surface configuration.

14. The flow control device of claim 8, wherein a transition between said converging portion and said diverging portion is continuous.

15. The flow control device of claim 8, wherein said conduit has a nominal diameter and a transition between said diverging portion and said nominal diameter is continuous.

16. A control system for ventilating a space with reduced noise generation, said control system comprising:
a conduit connected to the space that is adapted to transport air;
a blower fluidly connected to said conduit that forces air through said conduit;
a flow control device disposed in said conduit for controlling said flow of fluid in said conduit; said flow control device having an axis and defining a passage that allows fluid to flow through said conduit and including a converging portion, a diverging portion, and a throat therebetween; said diverging portion having a predetermined diffusion angle for a length sufficient to reduce said generation of noise as fluid flows through said valve.

17. The control system of claim 16, wherein said diverging portion of the fluid control device has a diffusion angle between 5° and 12°.

18. The control system of claim 16 wherein said conduit is an exhaust conduit said blower is an exhaust blower that draws air through said conduit.

19. The control system of claim 18, further comprising:
a supply conduit for supplying the space with air;
a flow control device disposed in said supply conduit for controlling the flow through said supply conduit, said supply control valve having a nozzle with a converging and diverging portion and a throat therebetween;
said diverging portion having a diffusion angle less than 20°.

20. The control system of claim 19, wherein said diverging portion has a diffusion angle between 5° and 12°.
